(19) United States
(12) Patent Application Publication
(10) Pub. No.: US 2005/0175758 A1
(43) Pub. Date: Aug. 11, 2005

(54) Rapid-action agent for preparing cold and hot beverages from drinking water

(76) Inventors: Helmut Korber, Halle/S. (DE); Friedemann Pieschel, Wolfen (DE); Petra Hitschler, Sandersdorf (DE); Michael Knieling, Berlin (DE)

Correspondence Address: LERNER AND GREENBERG, PA, P O BOX 2480, HOLLYWOOD, FL, 33022-2480, US

(21) Appl. No.: 10/511,005

(22) PCT Filed: Apr. 8, 2003
(86) PCT No.: PCT/EP03/03632

(30) Foreign Application Priority Data
Apr. 9, 2002 (DE) 10215642.5

(51) Int. Cl. C12C 1/00

(52) U.S. Cl. 426/590

(57) ABSTRACT

The invention relates to a fast-acting composition for preparing cold and hot drinks from drinking water, in particular coffee or tea. Starting from the disadvantages of the known prior art, it is an object of the invention to provide a fast-acting composition for preparing cold and hot drinks from drinking water which is simple to handle, has a uniformly constant action, excludes the risk of microbe formation and, after a relatively short treatment time of the drinking water, leads to a noticeable improvement in taste of the drink. For this, as a solution a composition is proposed which consists of cellulose fibers which are modified by chemical reaction with formation of phosphate ester groups and have an ion-exchange capacity of at least 50 mg of copper/g of dried fiber, this composition being contacted by immersion with the drinking water or brewing water at least briefly, for a period of a plurality of minutes. The chemical modification is performed by phosphorylating the cellulose fibers with phosphoric acid or ammonium phosphate up to a phosphorus content of from 3 to 8% by mass. To increase the mechanical stability of the fibers, the phosphorylation can additionally be combined with a carbamidation with urea up to a nitrogen content of at least 1% by mass in the form of carbamide groups. The modified cellulose fibers are so rapid in their action that after immersion in the preparation water, even after only a few minutes, if appropriate supported by a gentle stirring motion, a noticeable taste improvement of the drinking water and the drinks prepared therefrom is achieved, without disadvantageous effect on the aroma of the respective drink.

Fast-acting agent for preparing cold and hot drinks from drinking water

The invention relates to a fast-acting agent for preparing cold and hot drinks from drinking water, in particular coffee or tea.

Drinking water used for the preparation of cold and hot drinks, for example coffee or tea, also has an effect on the taste of the drink. The quality of the drinking water differs greatly by site, in particular with respect to hardness, which is affected by calcium and magnesium compounds. Especially when various tea types are brewed, a slightly iridescent film forms on the surface, and on the wall of the tea or drinking vessel, an unsightly deposit is formed, which are due to the drinking water used. To improve the drinking water for food preparation, it is already known to soften the drinking water by using filter apparatuses having water filters in the form of filter inserts or filter cartridges. The customary filters generally contain a mixture of weakly acidic cation exchangers in the H form and an activated carbon fraction. The filters have only a limited absorption capacity and their performance is weakened even after a short service time. The filter cartridges must be inserted into the filter apparatus, changed monthly and kept continuously in contact with water. The actual water filter must be washed regularly and protected from sunshine. The filtered water must be used within two days. The microbicidal substance used is silver in dissociable form. The filter cartridges must be preswollen in water for 20 minutes before use. On account of the initially excessive activity, the first two charges of filtered water must be discarded. The exhausted filter cartridges consist of plastic and must be disposed of separately. Filter systems of this type are very complicated in handling and require additional expenditure on care. A relatively long period is required for the necessary preparation of water for drinks.

The object underlying the invention is to provide a fast-acting composition for preparing cold and hot drinks from drinking water which is simple to handle, has a uniformly constant action, excludes the risk of microbe formation and, after a relatively short treatment time of the drinking water, leads to a noticeable improvement in taste of the drink.

According to the invention the object is achieved by the features specified in claim 1.

Further advantageous embodiments are the subject matter of claims 2 to 14. Advantageous uses are specified in claims 15 and 16. Surprisingly, it has been found that cellulose which is modified by chemical reaction with formation of phosphate ester groups in such a manner that the ion-exchange capacity is at least 50 mg of copper/g of dried fibers, even after short-term contact by immersion in the drinking water intended for preparation, leads to a marked improvement in taste. It has been found that phosphate ester groups have the advantage of very firmly binding calcium and heavy metal traces in contrast to carboxymethyl sulfate esters or other cation-exchanging groups. A H⁺ ion is released in the process, if the ester group is present as neutral alkali metal salt, and thus the carbonate hardness is additionally reduced. Any carbamide groups present do not influence these processes.

The chemical reaction takes place, for example, by phosphorylation of the cellulose fibers with phosphoric acid or ammonium phosphate up to a phosphorus content of from 3 to 8% by mass. Combined phosphorylation and carbamidation has also proved advantageous, in which the cellulose fibers are additionally carbamidated with urea up to a nitrogen content of at least 1% by mass, preferably up to 4% by mass present in the form of carbamide groups. Fibers of this type can be produced under particularly mild conditions and the ion-exchange capacity, for the same phosphorus content, is higher than with pure phosphorylation products.

Hitherto it has only been known that cellulose-containing materials which are carbamidated with urea and are phosphorylated with phosphoric acid or ammonium phosphate (DE 197 53 196 A1 and DE 199 24 435 A1) are used as biosorbent or filter material having ion-exchanging activity.

It has been found completely unexpectedly that the specially modified cellulose is so fast in its action that after immersion in the treatment water, even after only a few minutes, if appropriate supported by a slight stirring motion, a noticeable taste improvement of the drinking water and drinks prepared therefrom is achieved, without disadvantageous effect on the aroma of the respective drink. The modified cellulose can be used in various forms, for example as a piece of nonwoven fabric, as paper-like strips, or as loose fibers. The composition does not act as filter and also does not bind the flavor substances and aroma substances present in the drink. In specialist circles, this is considered improbable. This also relates to the activity occurring even after a short treatment time or immersion phase.

The composition can be added to a tea bag in the respective application form, or, in the form of fibers, can be introduced into a liquid-permeable bag to be suspended which is then suspended in the vessel which is filled with brew water or the cold drinking water. There is also the possibility of using, in particular the modified cellulose fibers, as starting material for producing filled or unfilled tea bags, if appropriate in combination with conventional tea bag production material.

In experiments it has also been found that, after the inventive treatment of drinking water, the otherwise typical mains water taste has completely disappeared.

A high phosphorus content achieved by the phosphorylation, if appropriate in combination with a carbamidation, leads firstly to a high ion-exchange capacity and thus to a high softening activity, but, secondly, also to a reduction of the mechanical stability of the fibers. Therefore, a phosphorus content of 8% by mass should not be exceeded. A nitrogen content higher than 4% by mass leads to no further improvement, but has a disadvantageous effect on the pollution of the wastewaters in the production process. In the production, it is therefore expedient to maintain a molar ratio of urea to phosphorus of 2.5:1 to 4.5:1. The carbamidation, and the resultant nitrogen content in the end product, achieves an improvement of the mechanical properties of the fibers.

Fibers that have proved to be particularly highly suitable are those having a P content of from 5 to 6.5% by mass, and an N content of from 2 to 3% by mass. These fibers have a capacity of from 100 to 130 mg of copper/g of dried fiber. Experiments have found that, using one gram of these fibers, the total hardness of one liter of water may be reduced by approximately 10° dH. Furthermore, it has been found that, for example, even hardness reductions of 3° dH have a strong beneficial effect on the appearance and taste of black tea, which may be achieved solely by brewing in the presence of the fibers. Furthermore, it has been found that even in very hard waters having more than 20° dH, an amount of from approximately 2.5 to 3.5 g of fibers per liter of drinking water is completely sufficient to achieve the sought-after effect. The amount of modified cellulose used per liter of drinking water should be between 0.5 g and 4 g, depending on the hardness of the drinking water used. With decreasing hardness, the amount used can be reduced correspondingly. Intensive contact between the drinking water and the fibers or other application forms promotes the activity. Nonwovens must not be too severely compressed and should as far as possible disintegrate in the water. Their weight per unit area can be from 100 to 500 g/m². Papers made from the fibers should be as water-permeable as possible and have weight per unit area of from 50 to 200 g/m².

The composition can be contacted with the drinking water before or during the heating of the water or else during the brewing operation. The modified cellulose fibers can be used alone or in a mixture with other fibers which are resistant to boiling. They can be used not only as loose fibers or as nonwoven fabric which is not reinforced in wet strength, in a water-permeable bag, but also in the form of paper-like strips.

The activity of the modified fibers to soften water and remove heavy metals which is known per se and is caused by ion exchange occurs so rapidly that even when its addition cannot start until during the brewing operation of tea or coffee and the like, virtually the same activity is still achieved. Even after a treatment time of only a few minutes, preferably from 3 to 10 min, sufficient activity is achieved. The composition can also remain in the drinking water longer. In the extreme case, however, after 30 minutes at the latest, all operations of softening water and removing heavy metals are completed. Immersion and occasional gentle movement, as is customary in brewing tea bags, is sufficient. In the case of tea beverages, the additional advantage further occurred that in the case of soluble cold drinks or hot drinks, the cloud otherwise forming on the surface, or separation of an iridescent surface skin and also unsightly deposits formed on the wall of the vessel were no longer observed. In the case of coffee, the flavor note of over-stored coffee due to the brewing water is improved toward aroma fullness, which becomes particularly noticeable in infusions having relatively low specific amounts of coffee used. The use of the inventive composition does not require preswelling, as is known of the known filter systems having ion-exchanging substances. The modified cellulose fibers do not absorb aroma substances and, owing to the removal of calcium, bicarbonate and heavy metals, cause a significant improvement in taste, and frequently also visual enhancement, of the drinks.

The modified cellulose fibers, after the preparation which is known per se from the abovementioned publications, are present in the ammonium form, and can be converted to the sodium form by treatment with a common salt solution.

For the intended application, however, it is advantageous to convert the fibers which arise in the ammonium form during the production into a mixed form having a small fraction of acid form to achieve improved activity against carbonate hardness. They are obtained by treatment with corresponding salt solutions at pHs of from 4 to 6. The potassium and magnesium forms are especially to be preferred, since these are suitable for making up deficits in mineral supply. An oversupply is also excluded if comparatively very hard water of 25° dH (total hardness) is treated with an excess of fiber and only drinks produced therewith are consumed (approximately 2 liters per day per person).

The modified cellulose fibers are only intended for single use and, in their respective application form, make possible exactly predetermined metering for the respective amount of water.

Since preswelling of the fibers is not required, microbial infection which is possible with the known water filters no longer plays any part.

The modified cellulose fibers may be produced inexpensively and are simple to handle in use. They have a convenient size and can be brought into contact with the drinking water either as suspended bags or as immersed strips. An inventively modified nonwoven fabric of dimensions 6 cm×9 cm (weight per unit area 500 g/m²) is completely sufficient even for treating an amount of drinking water of 1 liter of very hard water. After use, they may be disposed of readily, for example together with the biowaste of the coffee and tea residues. Compared with the known filter systems, the inventive composition has considerable advantages in use. It can be used immediately, achieves uniform and constant activity in use and requires no additional filter apparatuses or expenditure on care.

The invention will be described below with some examples.

A: Production

Fibers were produced in a known manner from pine sulfate pulp.

After conversion of a sample to the sodium form, elemental analysis showed a phosphorus content of 6.2% by mass and a nitrogen content of 2.7% by mass. The fibers have an ion-exchange capacity of 120 mg of copper/g of fiber. The fibers present in the ammonium form were then converted to the following forms by washing in a column using various salt solutions and/or acids:
A1: Using saturated common salt solution to the neutral sodium form.
A2: Using saturated potassium chloride solution which has been set to pH 3.5 using hydrochloric acid, to a mixed acid/potassium form.
A3: Using dilute magnesium sulfate solution acidified using sulfuric acid to pH 4 to a mixed acid/magnesium form.
A4: Fibers according to A1 were processed on a conventional papermaking machine to give wet-strength paper with addition of 25% pine sulfate pulp having a weight per unit area of 150 g/m².
A5: Fibers according to A3 were processed on a conventional papermaking machine to give wet-strength paper with addition of 25% pine sulfate pulp having a weight per unit area of 75 g/m².
A6: Fibers according to A2 were processed without addition of wet-strength agent or other fibers to give a nonwoven fabric having a weight per unit area of 500 g/m².
A7: Fibers according to A3 were processed without addition of wet-strength agent or other fibers to give a nonwoven fabric having a weight per unit area of 500 g/m².

### EXAMPLE 1

A piece of nonwoven fabric in the magnesium form produced according to A7 of size 6 cm×9 cm was placed in a commercially conventional unfilled tea bag of dimensions 6.5 cm×11 cm, laid in the water reservoir of a domestic coffee machine for 8 cups, and drinking water (11.8° dH carbonate hardness/25.8° dH total hardness) from the city of Halle/Saale was charged into the water reservoir. After placing a commercially conventional coffee filter into the coffee machine and charging the usual amount of coffee, the bag containing the nonwoven fabric was agitated several times in the water reservoir and the coffee machine was started. After 8 min, the coffee preparation was completed.

In a second identical coffee machine, coffee was prepared under the same conditions, but without immersing a piece of nonwoven fabric in the water reservoir.

For expert taste and visual appraisal of the coffee, the coffee-filled coffee cups were provided, for identification, with a numerical key which was only known by a person not participating in the expert appraisal. Each coffee was tested by 5 testing persons. Grades could be estimated according to questions given in advance. The means of evaluations carried out blind were taken.

The coffee produced without immersion of the nonwoven fabric in the coffee water had a significantly staler and somewhat more bitter taste and a significantly less aromatic odor.

### EXAMPLE 2

Coffee was brewed under the same conditions as in example 1, but, instead of the nonwoven fabric, a piece of paper (dimensions 12 cm×20 cm) in the sodium form, produced in accordance with A4, was placed in the water reservoir as a folded sheet.

The evaluation found a significantly staler and slightly more bitter taste and significantly less aromatic odor for the coffee produced without the filter paper in the water reservoir.

### EXAMPLE 3

A 1 liter water heater was filled with drinking water from the city of Halle/Saale and into this was placed a commercially conventional tea bag (6.5 cm×11 cm) which contained a 6 cm×9 cm-size piece of nonwoven fabric in the acid potassium form, produced according to A6. The heater was turned on. As soon as it had turned itself off, the hot water was used for manual coffee brewing using a coffee filter. The nonwoven fabric was present in the water for a period of 6 min.

The same process was carried out simultaneously using a second heater without using a nonwoven fabric.

Even during the filtering operation, the significantly more aromatic odor of the water heated in the presence of the nonwoven fabric was conspicuous.

The evaluation carried out in a similar manner to example 1 found, for the coffee produced without using the nonwoven fabric, a significantly staler and somewhat more bitter taste and a significantly less aromatic odor.

### EXAMPLE 4

300 ml of drinking water (4.2° dH carbonate hardness/15.7° dH total hardness) from the city of Berlin were heated to boiling in a tea kettle and poured into a teapot for two cups containing a commercial tea bag of black tea of type “Messmer Klassik” and three strips of paper (each 5 cm×10 cm) of the acid magnesium form, produced according to A5. After infusion for 5 minutes, the tea was poured into cups.

Using a second tea kettle, tea was prepared in a further teapot simultaneously under the same conditions, but without adding paper strips. The tea without addition of paper strips was, unlike that containing paper strips, cloudy after about 10 minutes, changed color from dark reddish brown to grayish black and obtained an iridescent skin. Even after half an hour, this difference was still clearly visible. The tea brewed with the use of paper strips had a significantly better flavor note. After they were emptied, the cups which had been filled with the tea produced using the paper strips were completely coat-free, and the other cups had a brown coat which was difficult to wash off on the inner wall.

### EXAMPLE 5

Tea was prepared using drinking water from the city of Halle/Saale under the same conditions as in example 4. The tea used was the type “Messmer Ceylon” and instead of the paper strips, there was placed into the water a further bag made of tea bag material containing 0.6 g of fibers in the acid potassium form, produced in accordance with A2.

On account of the lighter color of the tea variety, here the cloud in the tea which was brewed without addition of a fiber-filled bag was visible as soon as approximately 5 minutes after pouring. The tea which was brewed using a bag with addition of fibers was, even approximately 30 minutes after pouring, still transparently clear and had a significantly better flavor note.

### EXAMPLE 6

Paper produced according to A5 which contained 75% phosphorylated fibers in the acid Mg form, of a size 5 cm×10 cm, was immersed, with occasional swirling, in a vessel containing 200 ml of drinking water from the city of Berlin (4.2° dH carbonate hardness, 15.7° dH total hardness). After a period of 8 minutes, the paper was removed from the vessel and the water poured into cups. The taste of this drinking water was then compared with the same, but untreated, drinking water. It was found that the paper-treated water had a type of mineral water taste, and the otherwise typical mains water taste had been completely eliminated.

1-16. (canceled)

17. A fast-acting agent for preparing cold and hot drinks from a drink base and drinking water, by contact with said drinking water for a period of a plurality of minutes, comprising cellulose fibers modified by chemical reaction with formation of phosphate ester groups and having an ion-exchange capacity of at least 50 mg of copper/g of dried fiber.

18. The agent according to claim 17, wherein the cellulose fibers are modified by phosphorylation with phosphoric acid or ammonium phosphate up to a phosphorus content of from 3 to 8% by mass.

19. The agent according to claim 17, wherein said cellulose fibers are further modified by chemical reaction with formation of carbamide groups up to a nitrogen content of at least 1% by mass present in the form of carbamide groups and a phosphorus content of from 3 to 8% by mass.

20. The agent according to claim 19, wherein said carbamide groups are formed by chemical reaction of said cellulose fibers with urea.

21. The agent according to claim 17, wherein the amount of modified cellulose fibers used is from 0.5 g to 4 g per liter of drinking water.

22. The agent according to claim 19, wherein the upper limit of the nitrogen content is 4% by mass.

23. The agent according to claim 19, wherein the phosphorus content is from 5 to 6.5% by mass and the nitrogen content is from 2 to 3% by mass and the ion-exchange capacity is in the range from 100 to 130 mg of copper/g of dried fiber.

24. The agent according to claim 17, wherein the period of contact is from 3 to 10 min.

25. The agent according to claim 17, wherein at least some of said phosphate ester groups are phosphate ester salts selected from the group consisting of sodium, potassium, and magnesium phosphate ester salts.

26. The agent according to claim 25, wherein the modified cellulose fiber is converted into the sodium, potassium or magnesium form by subsequent treatment with a sodium, potassium, or magnesium salt solution.

27. The agent according to claim 25, wherein the modified cellulose fibers are converted into an acid/potassium or acid/magnesium form by subsequent treatment with an acidified salt solution and the fraction of free acid form has a pH of >3 in water.

28. A bag comprising water-permeable and food-standard material and an agent according to claim 17.

29. A wet strength paper product comprising wet-strengthened paper and an agent according to claim 17.

30. A non-woven fabric having a weight per unit area of from 100 to 500 g/m² and comprising fibers and an agent according to claim 17.

31. A water-permeable bag comprising fibers and an agent according to claim 17.

32. A feed material for production of tea bags comprising fibers and an agent according to claim 17.

33. A method to achieve a fast-acting taste improvement in the preparation of a drink from water and a drink base, wherein cellulose fibers modified by chemical reaction with formation of phosphate ester groups and by chemical reaction with formation of carbamide groups up to a nitrogen content of at least 1% by mass present in the form of carbamide groups and a phosphorus content of from 3 to 8% by mass, in the form of loose fibers, paper-like pieces, or as nonwoven fabric, are immersed in the preparation water for hot or cold drinks and removed therefrom after a plurality of minutes.

34. The method of claim 33, wherein the fibers are in the form of paper-like pieces or nonwoven fabric as additive to lay in tea bags or as feed material for producing tea bags.

35. The method of claim 33, wherein the drink base is coffee or tea.
